(19) United States
(12) Patent Application Publication
(10) Pub. No.: US 2026/0149193 A1
(43) Pub. Date: May 28, 2026

(54) SHEAR BOLT CONNECTOR

(71) Applicant: Eaton Intellectual Power Limited, Dublin (IE)

(72) Inventors: Alexander F. Groth, Milwaukee, WI (US); Nicholas John Wainio, Wales, WI (US)

(73) Assignee: Eaton Intelligent Power Limited, Dublin (IE)

(21) Appl. No.: 19/396,975

(22) Filed: Nov. 21, 2025

Related U.S. Application Data
(60) Provisional application No. 63/725,574, filed on Nov. 27, 2024.

(51) Int. Cl. H01R 4/36; F16B 31/02

(52) U.S. Cl. CPC H01R 4/36; F16B 31/021

(57) ABSTRACT

A shear bolt connector including: a body including: a sidewall that extends along an axis from a first end to a second end, the sidewall including: an exterior and an interior, where the interior is open at the second end and configured to receive an electrical cable, a portion of the exterior includes a planar region that extends along the axis and defines one or more passages to the interior, and each of the one or more passages is configured to receive a shear bolt.

### CROSS-REFERENCE TO RELATED APPLICATION

This application claims priority to U.S. Provisional Application No. 63/725,574, filed Nov. 27, 2024 and titled SHEAR BOLT CONNECTOR, which is incorporated herein by reference in its entirety.

### TECHNICAL FIELD

This disclosure relates to a shear bolt connector.

### BACKGROUND

A shear bolt connector includes a body with an open interior. An electrical conductor is received in the open interior and secured to the body with a shear bolt.

### SUMMARY

In one aspect, a shear bolt connector including: a body including: a sidewall that extends along an axis from a first end to a second end, the sidewall including: an exterior and an interior, where the interior is open at the second end and configured to receive an electrical cable, a portion of the exterior includes a planar region that extends along the axis and defines one or more passages to the interior, and each of the one or more passages is configured to receive a shear bolt.

Implementations may include one or more of the following features.

The interior may have a circular cross-section in a plane perpendicular to the planar region.

The sidewall may have a non-uniform thickness between the exterior and the interior, and the thickness may vary from a minimum thickness to a maximum thickness. The maximum thickness may be on both sides of the planar region.

The body may be asymmetrical about a line perpendicular to the axis.

Each of the one or more passages may include an inner threaded wall.

The shear bolt connector also may include a base that extends from the body, the base including an opening configured to receive an electrical connector. The base and the body may be configured for insertion into an interior cavity of an electrical connector. The base and the body may be configured for insertion into an interior cavity of one or more of an elbow connector and a T-connector. The one or more passages and the opening may extend in the same direction.

In another aspect, a system includes: a body including a sidewall that defines an interior region and one or more bolt openings that pass through the sidewall, the interior region is open at a first end of the body and is configured to receive an electrical cable, and each of the one or more bolt openings is configured to receive a shear bolt; and a base portion extending from a second end of the body, the base portion defining a conductor opening configured to receive an electrical conductor. The body and the base portion are configured for insertion into an electrical connector.

Implementations include one or more of the following features.

The body may extend along an axis, and the body may have a variable diameter in a plane perpendicular to the axis. The body may include an exterior, and the exterior may include a planar region. The interior region may have a circular cross-section in a plane perpendicular to the axis.

Each of the one or more bolt openings may include a threaded inner wall.

The body may extend along an axis, and the body may be asymmetrical about a line perpendicular to the axis.

Implementations of any of the techniques described herein may include an apparatus, a shear bolt connector, a method, or a system. The details of one or more implementations are set forth in the accompanying drawings and the description below. Other features will be apparent from the description and drawings, and from the claims.

### DRAWING DESCRIPTION

FIG. 1A is a side exterior view of a shear bolt connector.

FIG. 1B is a top exterior view of the shear bolt connector of FIG. 1A.

FIG. 1C is an exterior view of an end of the shear bolt connector of FIG. 1A and a side exterior view of a shear bolt that may be used with the shear bolt connector of FIG. 1A.

FIG. 1D is a side cross-sectional view of a bolt passage.

FIG. 2 shows a cross-sectional view of a system.

FIG. 3A is a perspective view of another shear bolt connector.

FIG. 3B is a perspective view of the shear bolt connector of FIG. 3A with shear bolts attached.

FIG. 3C is an external end view of the shear bolt connector of FIG. 3A with shear bolts attached.

FIG. 3D is a top external view of the shear bolt connector of FIG. 3A with shear bolts attached.

FIG. 3E is a side external view of the shear bolt connector of FIG. 3A with shear bolts attached.

### DETAILED DESCRIPTION

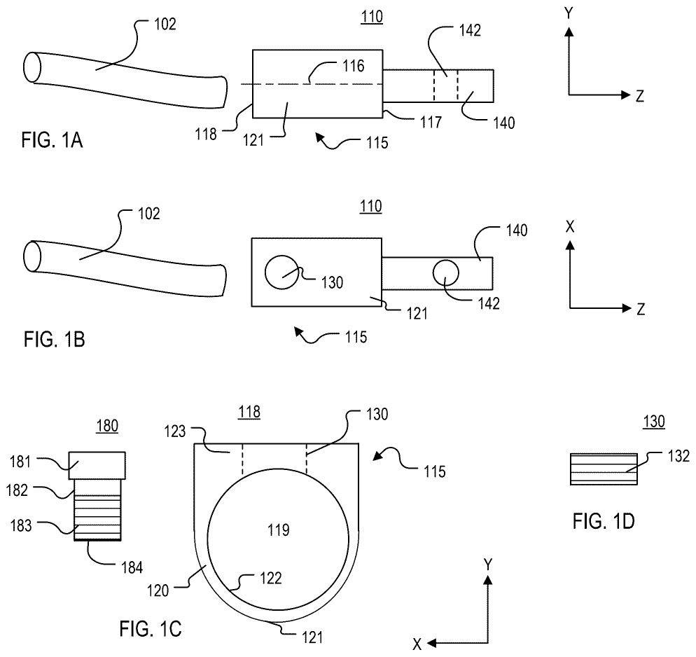

FIGS. 1A-1D relate to a shear bolt connector 110. As discussed below, the shear bolt connector 110 provides a secure electrical connection point for an electrical cable 102 and has a compact design that allows the shear bolt connector 110 to be placed inside a cable connector that has a relatively low current rating (for example, 200 Amperes or lower).

FIG. 1A is a side exterior view of a shear bolt connector 110. FIG. 1B is a top exterior view of the shear bolt connector 110. FIG. 1C is an exterior view of an end 118 of the shear bolt connector 110 and a side exterior view of a shear bolt 180 that may be used with the shear bolt connector 110. In FIGS. 1A and 1C, the dotted lines represent hidden elements.

The shear bolt connector 110 includes a body 115 having a sidewall 120 that extends along an axis 116 (shown with a dash-dot line in FIG. 1A) from a first end 117 to the second end 118. The second end 118 is open to an interior region 119. The sidewall 120 has an exterior 121 and an inner side 122 that faces the interior region 119. A bolt passage 130 passes through the sidewall 120 in the Y direction. Referring also to FIG. 1D, which is a side cross-sectional view of the bolt passage 130, the bolt passage 130 includes threads 132.

The bolt connector 110 also includes a base 140 that extends from the first end 117 of the body 115. The base 140 defines a conductor opening 142, which passes through the base 140 in the Y direction. The base 140 and the inner side 122 are made of an electrically conductive material such as, for example, a plated aluminum alloy, aluminum, brass, copper, and/or gold and are in physical contact. For example, the base 140 and the body 115 may be a single piece of metal.

In operational use, the electrical cable 102 is inserted through the open second end 118 and into the interior region 119. The portion of the electrical cable 102 that is inserted into the interior region 119 is electrically conductive. For example, if the electrical cable 102 includes an insulating jacket, the jacket is stripped back to expose the electrical conductors of the cable 102 and the exposed electrical conductors are inserted into the interior region 119. An end 184 of the shear bolt 180 is inserted into the bolt passage 130. Torque is applied to a head 181 of the shear bolt 180, tightening the bolt 180 by threading threads 183 of the bolt 180 with the threads 132 and moving a distal end 184 of the bolt body 182 toward the inner side 122 until the distal end 184 holds the electrical conductors securely against the inner side 122. The engagement between the threads 132 and the threads 183 secures the bolt body 182 in the bolt passage 130 and maintains the electrical connection between the conductors of the cable 102 and the inner side 122. The inner side 122 and the base 140 are made of an electrically conductive material and are physically connected. Thus, when the electrical conductors are held in contact with the inner side 122, the electrical cable 102 is electrically connected to the base 140. When a pre-determined amount of force is applied to the head 181, the head 181 breaks off such that the bolt body 182 is substantially flush with the body 115.

Legacy bolt connectors are generally designed for use in applications having a current rating of 600 Amperes (A) or greater. On the other hand, the shear bolt connector 110 is designed for use in lower amperage applications, such as applications at 200 A or lower. The shear bolt connector 110 is smaller than the legacy, higher amperage bolt connectors. For example, the interior region 119 and the outer cross-sectional diameter of the shear bolt connector 110 are smaller than on the legacy higher amperage bolt connectors so that the shear bolt connector 110 can accommodate the smaller cables and electrical connectors that are used in low amperage applications.

As discussed above, the bolt body 182 holds the electrical cable 102 against the inner side 122, and the engagement between the threads 183 on the bolt body 182 and the threads 132 in the bolt passage 130 ensures that the bolt body 182 remains in the passage 130 and continues to hold the electrical cable 102 in contact with the inner side 122. Simply reducing the size of a legacy bolt connector intended for use in a high amperage application would reduce the number of threads and the length of the threaded passage, thereby reducing the amount of force holding the bolt body in the connector body. This reduction in force can reduce the surface contact on the cable conductor and could lead to loss of electrical contact between the cable conductor and the bolt body.

On the other hand, in the shear bolt connector 110, the cross-section of the body 115 in the X-Y plane is asymmetrical and the sidewall is relatively thicker in a portion 123 that is around and/or includes the bolt passage 130. For example, the sidewall 120 may be thickest in the portion 123. This allows the bolt passage 130 to have sufficient threads and to have a sufficient length to hold the body 182 of the shear bolt 180 securely even through the overall size of the bolt connector 110 is smaller than a legacy bolt connector.

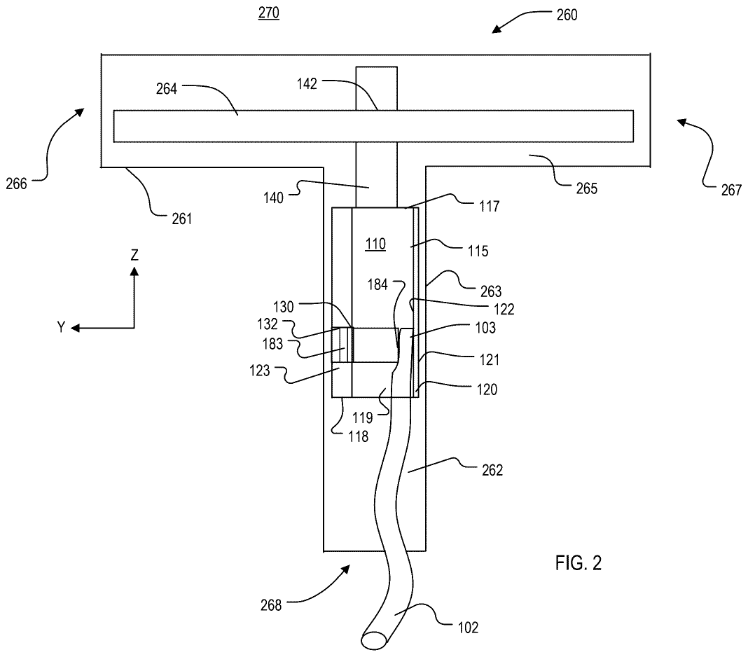

FIG. 2 shows a cross-sectional view of a system 270. The system 270 includes a T-shaped connector 260 and the assembled bolt connector 110 in an interior space 262 of the T-shaped connector 260.

The T-shaped cable connector 260 is a separable connector and can be repeatedly attached to and removed from a bushing or other electrical and/or mechanical connection point. The T-shaped cable connector 260 includes an electrically insulating housing that includes a first portion 261 that extends along the Y axis and a second portion 263 that extends along the Z axis. The electrically insulating housing may be made of a rubber material, such as, for example, ethylene propylene diene monomer (EPDM) rubber. The second portion 263 is open at an end 268. The first portion 261 is open at ends 266 and 267.

The bolt connector 110 is assembled prior to being placed in the interior space 262. To assemble the bolt connector 110, an end 103 of the electrical cable 102 is inserted into the interior region 119. The end 103 has exposed electrically conductive portions. For example, the electrical cable 102 may be an insulated cable and, in these implementations, the insulation is removed at the end to expose the electrically conductive portions. In another example, the end 103 may be an electrically conductive clip or plug that extends from the cable 102. The end 184 of the shear bolt 180 is inserted into the passage 130.

Torque is applied to the bolt head 181 (FIG. 1C) to thread the threads 183 on the bolt body 182 to the threads 132 in the passage 130. The exposed conductive portions of the cable 102 are captured between the end 184 of the bolt body 182 and the inner side 122 of the body 115. The end 184 continues to hold the conductive portions 103 of the cable 102 securely against the inner side 122 because of the engagement between the bolt threads 183 and the passage threads 132. Additionally, the torque applied to the bolt head 181 separates the bolt head 181 from the bolt body 182.

The assembled bolt connector 110 is inserted through the open end 268 and into the interior space 262 of the T-shaped cable connector 260. The assembled bolt connector 110 is held in the interior space 262 by an interaction between the exterior 121 of the sidewall 120 and an inner wall of the second portion 263 of the cable connector 260. For example, the assembled bolt connector 110 may be held in the interior space 262 by a frictional engagement and/or an adhesive between the inner surface of the second portion 263 and the exterior 121 of the sidewall 120. When the assembled bolt connector 110 is fully inserted into the cable connector 260, the body 115 is in the interior space 262, and the base 140 extends into an interior region 265 of the first portion 261 of the electrically insulating housing with the conductor opening 142 extending along the Y axis.

An electrical conductor 264 is inserted through the conductor opening 142. The electrical conductor 264 is in contact with the base 140, which is electrically connected to the inner side 122. The conductive end 103 of the electrical cable 102 is held in contact with the inner side 122. Thus, the electrical conductor 264 is electrically connected to the electrical cable 102. Moreover, the electrical conductor 264 is accessible from the openings 166 and 167 such that the electrical conductor 264 can be electrically connected to an external electrical device. For example, the open end 266 may be attached to a bushing of an external electrical device to electrically connect the cable 102 to the external electrical device.

The T-shaped cable connector 260 is rated for use for relatively lower amperages, such as, for example, 200 A and less. The T-shaped cable connector 260 is smaller than cable connectors designed for use at higher currents, such as connectors rated for use at 600 A or greater. As discussed above, the bolt connector 110 has a compact size and can be inserted into the interior space 262. Moreover, although the bolt connector 110 is small enough to fit into the interior space 262, the asymmetrical shape of the body 115 ensures that the contact and engagement between the threads 132 and the threads 183 is sufficient to hold the conductive end 103 of the cable 102 against the inner side 122. Accordingly, although the bolt connector 110 is small enough to fit into a lower amperage cable connector (such as the cable connector 260), the bolt connector 110 still maintains electrical contact between the conductive end 103 and the inner side 122.

The assembled bolt connector 110 may be inserted into other separable connectors. For example, the assembled bolt connector 110 may be inserted into a separable elbow connector. Regardless of the specific configuration of the separable connector, the assembled bolt connector 110 is small enough to be inserted into a lower-amperage separable connector, such as a connector rated for amperages of 200 A or less.

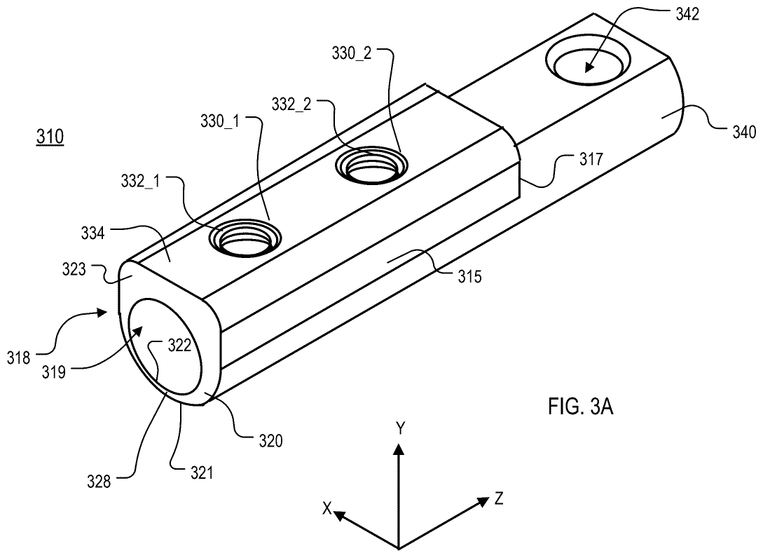

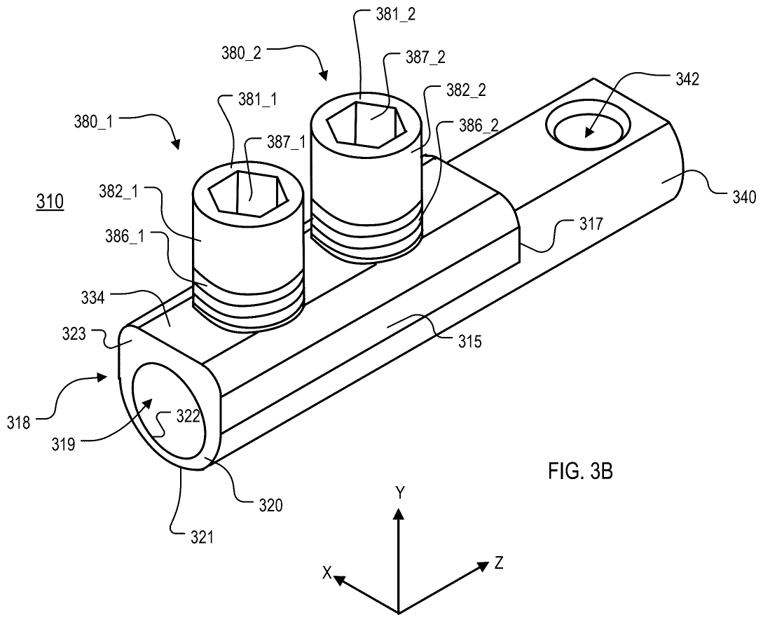

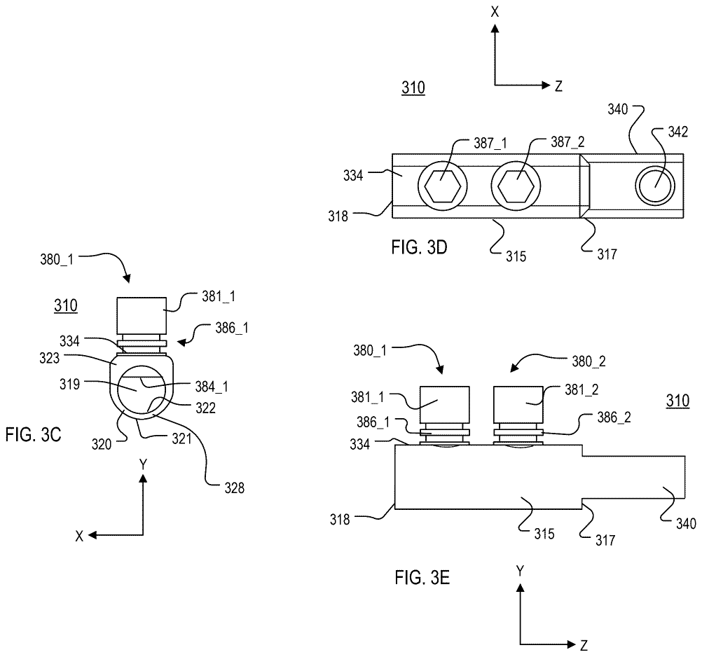

FIGS. 3A-3E relate to another bolt connector 310. The bolt connector 310 can be assembled and inserted into a separable electrical connector, such as the T-shaped cable connector 260. FIG. 3A is a perspective view of the bolt connector 310. The bolt connector 310 includes a body 315 that extends in the Z direction from an end 318 to an end 317, and a base 340 that extends from the body 315 in the Z direction. The body 315 and the base 340 are made of an electrically conductive material, such as, for example, brass, aluminum, an aluminum alloy, tin, silver, copper, or gold. Additionally, the body 315 and the base 340 are in physical contact with each other and are thus electrically connected.

The base 340 includes a conductor opening 342 that passes through the base 340 in the Y direction. The body 315 includes a sidewall 320 that has an exterior 321 and an interior 322, which defines an open interior region 319. The interior region 319 is substantially circular in the X-Y plane, but the sidewall 320 has a variable thickness in the X-Y plane. For example, the body 315 includes an attachment portion 323 that has a greater radial thickness than a bottom portion 328 of the sidewall 320. In other words, the spatial center of the exterior 321 of the sidewall 320 in the X-Y plane and the spatial center of the interior region 319 are not the same, and the exterior surface of the sidewall 320 and the interior region 319 are non-concentric. The body 315 includes two threaded passages 330_1, 330_2 that extend through a flat portion 334 and the attachment portion 323 of the body 315. Each threaded passage 330_1, 330_2 includes respective threads 332_1, 332_2.

FIG. 3B is a perspective view of the bolt connector 310 with a shear bolt 380_1, 380_2 attached, respectively, to the threaded passage 330_1, 330_2. FIG. 3C is an external view of the end 318 with the shear bolt 380_1 attached to the body 315. FIGS. 3D and 3E are top and side, respectively, external views of the bolt connector 310 with the shear bolts 380_1, 380_2 attached to the body 315.

Each shear bolt 380_1, 380_2 includes a bolt head 381_1, 381_2; a body 382_1, 382_2; and a break region 386_1, 386_1. Each bolt head 381_1, 381_2 includes respective torque tool opening 387_1, 387_2. Each shear bolt 380_1, 380_2 includes threads (not shown) that engage with the threads 332_1, 332_2 (FIG. 3A). To secure the shear bolt 380_1 to the body 315, an end 384_1 (FIG. 3C) is inserted into the passage 330_1. A torque tool (for example, an allen wrench) is inserted into the torque tool opening 387_1 to apply torque to the bolt head 381_1. The applied torque rotates the bolt head 381_1 to thread the shear bolt 380_1 to the threads 332_1 (FIG. 3A). The shear bolt 380_2 is attached to the threads 332_2 (FIG. 3A) in the same manner.

Referring also to FIG. 3C, which is an exterior view of the end 318 of the body 315, the end 384_1 of the shear bolt 380_1 extends into the interior region 319. The thickness of the sidewall 320 varies in the X-Y plane, with the thickest portions of the sidewall 320 being in the attachment portion 323 that is adjacent to the flat portion 334. The passages 330_1 and 330_2 pass through the attachment portion 323. In some implementations, the radial thickness of the sidewall 320 varies from a minimum of about 0.1 inches (in) or 2.54 millimeter (mm) in the bottom portion 328 to about 0.125 in (3.17 mm) in the attachment portion 323. Moreover, the overall size of the bolt connector 310 is relatively small and may be used in lower amperage applications. For example, the outer width of the body 315 in the X-Y plane may be 0.625 in (or 15.87 mm).

The sidewall 320 has mirror symmetry about the Y axis but is not symmetrical about the X axis. As compared to a design in which the sidewall is symmetric about the X and Y axis, has a uniform radial thickness, or a design in which the bolt connector has a sidewall that is concentric with the center of the interior region surrounded by the sidewall, the sidewall 320 provides more space in the Y direction for the threaded passages 330_1 and 330_2. Thus, the design of the sidewall 320 and the inclusion of the attachment portion 323 and flat portion 334 allows the passages 330_1 and 330_2 to have a greater number of threads and/or a greater thread density. The increased length of the passages 330_1 and 330_2 and the increased number of threads allows the bolts 380_1 and 380_2 to be held securely in the body 315 even though the overall size of the bolt connector 310 is smaller than a typical bolt connector.

In operational use, the bolt heads 381_1, 381_2 are separated from the bolts 380_1, 380_2. An electrically conductive portion of an electrical cable is held against the interior 322 by the ends of the bolts 380_1, 380_2. The interior 322 is electrically conductive and is electrically connected to the base 340. In this way, the electrical cable can be electrically connected to a conductor that passes through the conductor opening 342.

These and other implementations are within the scope of the claims.

What is claimed is:

1. A shear bolt connector comprising:
a body comprising: a sidewall that extends along an axis from a first end to a second end, the sidewall comprising: an exterior and an interior, wherein the interior is open at the second end and configured to receive an electrical cable, a portion of the exterior comprises a planar region that extends along the axis and defines one or more passages to the interior, and each of the one or more passages is configured to receive a shear bolt.

2. The shear bolt connector of claim 1, wherein the interior has a circular cross-section in a plane perpendicular to the planar region.

3. The shear bolt connector of claim 1, wherein the sidewall has a non-uniform thickness between the exterior and the interior, and the thickness varies from a minimum thickness to a maximum thickness.

4. The shear bolt connector of claim 3, wherein the maximum thickness is on both sides of the planar region.

5. The shear bolt connector of claim 1, wherein the body is asymmetrical about a line perpendicular to the axis.

6. The shear bolt connector of claim 1, wherein each of the one or more passages comprises an inner threaded wall.

7. The shear bolt connector of claim 1, further comprising a base that extends from the body, the base comprising an opening configured to receive an electrical connector.

8. The shear bolt connector of claim 7, wherein the base and the body are configured for insertion into an interior cavity of an electrical connector.

9. The shear bolt connector of claim 8, wherein the base and the body are configured for insertion into an interior cavity of one or more of an elbow connector and a T-connector.

10. The shear bolt connector of claim 7, wherein the one or more passages and the opening extend in the same direction.

11. A system comprising:
a body comprising a sidewall that defines an interior region and one or more bolt openings that pass through the sidewall, wherein the interior region is open at a first end of the body and is configured to receive an electrical cable, and each of the one or more bolt openings is configured to receive a shear bolt; and
a base portion extending from a second end of the body, the base portion defining a conductor opening configured to receive an electrical conductor, wherein the body and the base portion are configured for insertion into an electrical connector.

12. The system of claim 11, wherein the body extends along an axis, and the body has a variable diameter in a plane perpendicular to the axis.

13. The system of claim 12, wherein the body comprises an exterior, and the exterior comprises a planar region.

14. The system of claim 13, wherein the interior region has a circular cross-section in a plane perpendicular to the axis.

15. The system of claim 11, wherein each of the one or more bolt openings comprise a threaded inner wall.

16. The system of claim 11, wherein the body extends along an axis, and the body is asymmetrical about a line perpendicular to the axis.
